(19) United States
(12) Patent Application Publication
(10) Pub. No.: US 2017/0323289 A1
(43) Pub. Date: Nov. 9, 2017

(54) A SIMULATION APPARATUS, A REAL CARD MANAGER AND A DATA INTERACTIVE SYSTEM

(71) Applicant: TENDYRON CORPORATION, Beijing (CN)

(72) Inventor: Dongsheng Li, Beijing (CN)

(21) Appl. No.: 15/531,927

(22) PCT Filed: Nov. 16, 2015
(86) PCT No.: PCT/CN2015/094732

§ 371 Date: May 31, 2017

(30) Foreign Application Priority Data
Feb. 3, 2015 (CN) 201510056001.2
Feb. 3, 2015 (CN) 201510056002.7
Feb. 3, 2015 (CN) 201510056264.3

(51) Int. Cl. G06Q 20/34; G06Q 20/38

(52) U.S. Cl. CPC G06Q 20/34; G06Q 20/382

(57) ABSTRACT

Provided in the present disclosure are a simulation apparatus, real card manager and data interactive system. The apparatus includes: a first interface, configured to receive first data; a security module, configured to process the first data to obtain second data; and a wireless interface, configured to send the second data to a real card manager; in which the wireless interface is further configured to receive third data sent by the real card manager and to send the third data to the security module; the security module is further configured to receive the third data sent by the wireless interface, to process the third data to obtain fourth data, and to send the fourth data to the first interface; and the first interface is further configured to receive the fourth data sent by the security module and to send the fourth data to the terminal.

### CROSS-REFERENCE TO RELATED APPLICATION

This application is a Section 371 U.S. National Phase Application based of International Application No. PCT/CN2015/094732, filed Nov. 16, 2015, an published on Aug. 11, 2016, not in English, which claims priority to and benefits of Chinese Patent Application Serial Nos. 201510056002.7, 201510056264.3 and 201510056001.2, all filed with the State Intellectual Property Office of P. R. China on Feb. 3, 2015, the entire contents of which are incorporated herein by reference.

### TECHNICAL FIELD

The present disclosure relates to the field of electronic information security technology, and particular to, a simulation apparatus, a real card manager and a data interactive system.

### BACKGROUND

In present transaction procedures, such as withdrawing money or swiping a card for shopping, a user generally needs to carry a bank card issued by a bank with him There is a security risk when the user carries the bank card with him Once the bank card is lost, it is possible to make the user suffer a loss of money. Furthermore, as there are various bank cards, one user may hold many bank cards from different banks. Therefore, it is inconvenient that the user need to carry lots of different bank cards with him for transaction.

As a result, it is urgent to provide with a solution for making the transaction convenient for the user and having high security.

### SUMMARY

Embodiments of the present disclosure provide a simulation apparatus, including:

a first interface, configured to receive first data sent by a terminal;

a security module, configured to receive the first data sent by the first interface and to process the first data to obtain second data; and

a wireless interface, configured to receive the second data sent by the security module and to send the second data to a real card manager;

in which the wireless interface is further configured to receive third data sent by the real card manager and to send the third data to the security module;

the security module is further configured to receive the third data sent by the wireless interface, to process the third data to obtain fourth data, and to send the fourth data to the first interface; and

the first interface is further configured to receive the fourth data sent by the security module and to send the fourth data to the terminal.

Embodiments of the present disclosure provide a real card manager, including: a wireless interface, configured to receive first data sent by a simulation apparatus; a security module, configured to receive the first data sent by the wireless interface and to process the first data to obtain second data; one or more reading/writing interfaces, configured to receive the second data sent by the security module and to send the second data to a real card; in which the one or more reading/writing interfaces are further configured to receive third data sent by the real card and to send the third data to the security module; the security module is further configured to receive the third data sent by the one or more reading/writing interfaces, to process the third data to obtain fourth data, and to send the fourth data to the wireless interface; and the wireless interface is further configured to receive the fourth data sent by the security module and to send the fourth data to the simulation apparatus; an input module, configured to input fifth data; and a prompt module, configured to play sixth data as a prompt; in which the security module is further configured to receive the fifth data inputted via the input module and to send the sixth data to the prompt module.

Embodiments of the present disclosure provide a data interactive system, including a simulation apparatus and a real card manager, in which the simulation apparatus is configured to receive first data sent by a terminal, to process the first data to obtain second data and to send the second data to the real card manager; the real card manager is configured to receive the second data sent by the simulation apparatus, to process the second data to obtain third data, and to send the third data to a real card; the real card manager is further configured to receive fourth data sent by the real card, to process the fourth data to obtain fifth data, and to send the fifth data to the simulation apparatus; and the simulation apparatus is further configured to receive the fifth data sent by the real card manager, to process the fifth data to obtain sixth data, and to send the sixth data to the terminal.

### BRIEF DESCRIPTION OF THE DRAWINGS

In order to make technical solutions provided by embodiments of the present disclosure more clearly, simple description will be made on drawings required in illustration of the embodiments. It is apparently that, the drawings in following description are merely embodiments of the present disclosure. For those skilled in the art, other drawings will be obtained according to these drawings without any inventive labors.

FIG. 1 is a schematic diagram of a simulation apparatus provided by embodiment 1 of the present disclosure;

FIG. 2 is a schematic diagram of a simulation apparatus provided by embodiment 2 of the present disclosure;

FIG. 3 is a schematic diagram of a simulation apparatus provided by embodiment 3 of the present disclosure;

FIG. 4 is a schematic diagram of a simulation apparatus provided by embodiment 4 of the present disclosure;

FIG. 5 is a schematic diagram of a simulation apparatus provided by embodiment 5 of the present disclosure;

FIG. 6 is a schematic diagram of a real card manager provided by embodiment 9 of the present disclosure;

FIG. 7 is a schematic diagram of a reading/writing interface shown in a first structure of a real card manager provided by the present disclosure;

FIG. 8 is another schematic diagram of a reading/writing interface shown in a first structure of a real card manager provided by the present disclosure;

FIG. 9 is a schematic diagram of a real card manager provided by embodiment 10 of the present disclosure;

FIG. 10 is a schematic diagram of a reading/writing interface shown in a second structure of a real card manager provided by the present disclosure;

FIG. 11 is another schematic diagram of a reading/writing interface shown in a second structure of a real card manager provided by the present disclosure;

FIG. 12 is a schematic diagram of a data interactive system according to the present disclosure.

### DETAILED DESCRIPTION

Technical solutions of embodiments of the present disclosure will be described in detail and completely in combination with drawings provided in the embodiments of the present disclosure. It is apparently that, embodiments described herein are merely parts of embodiments rather than all embodiments. On the basis of the embodiments of the present disclosure, all other embodiments obtained by those skilled in the art without any inventive labors are covered in the scope of the present disclosure.

In the description, it is to be understood that orientations or position relations of the device or elements indicated by terms (such as “central”, “longitudinal”, “lateral”, “upper”, “lower”, “front”, “rear”, “right”, “left”, “vertical”, “horizontal”, “top”, “bottom”, “inner”, “outer”) used herein should be construed to refer to the orientations or position relations as then described or as shown in the drawings under discussion for simplifying the description of the present disclosure, but do not alone indicate or imply that the device or element referred to must have particular orientations or must be constructed or operated in particular orientations. In addition, terms such as “first” and “second” are used herein for purposes of description and are not intended to indicate or imply relative importance or significance.

In the description, unless specified or limited otherwise, the terms “mounted,” “connected,” and “coupled” and variations thereof are used broadly and encompass such as fixed, removable or integrated connections and couplings, also can be mechanical or electrical mountings, connections and couplings, and further can be direct and indirect connections and couplings via intermediary, and further can be inner connections and couplings between two components, which can be understood by those skilled in the art according to the detail embodiment of the present disclosure.

Embodiments of the present disclosure will be described further in detail with reference to the drawings.

Embodiments of the present disclosure provide a data interaction architecture, which provides a solution for making a transaction convenient for a user and with high security. The data interaction architecture includes: a simulation apparatus and a real card manger.

The simulation apparatus: one or more simulation apparatuses may be included in the data interaction architecture. Each simulation apparatus may only belong to and be managed by one real card manager. The simulation apparatus may be a simulation card (i.e. a device made in a shape like a card separately), or may be a real card with functions of the simulation apparatus. The simulation card may have a same size with a bank card. A transaction may be performed using the simulation card instead of a real card in the data interaction architecture.

Certainly, the simulation apparatus according to the present disclosure may be a mobile device with simulation apparatus functions, including: a smart phone, a Tablet Personal Computer (Tablet PC for short), a personal digital assistant (PDA for short) (such as a palm computer, a learning machine), a laptop, an electronic reading device, a wearable device (such as a smart watch, a smart glasses, etc.) and the like. Alternatively, the simulation apparatus according to the present disclosure may be an electronic signature token (a key token with a digital certificate and a private key for digital signing and with a interface for communicate with a computer or a smart phone, such as a Key Token of Industrial and Commercial Bank of China, or a Key Token of Agricultural Bank of China).

Certainly, the simulation apparatus according to the present disclosure may be a combination of the mobile device and the electronic signature token. The simulation apparatus may cooperate with an existing terminal to perform data interaction. The existing terminal may include a payment terminal, a functional terminal and the like. For example, the payment terminal may include a transaction type terminal for financial transactions, e.g. a payment initiated terminal, such as a smart phone, a PAD, a laptop, a smart wearable device, an ATM (automatic teller machine), a POS (point of sale) machine, a auto-recharge machine for public transport card, a Portable card reader and the like. For another example, the functional terminal includes a service terminal, e.g. a service initiated terminal, such as an entrance guard, a point card management terminal and the like. Further, the simulation apparatus may perform the data interaction with the real card manager.

Specifically, the simulation apparatus may be used by communicating with the terminal via contacts and/or NFC (Near Field Communication) when the simulation apparatus is a card shaped device; the simulation apparatus may be used by communicating with the terminal via the NFC when the simulation apparatus is configured as a smart phone. The terminal in the present disclosure may be a card reading terminal to read data from the simulation apparatus, or a card reading/writing terminal to read data from the simulation apparatus or to write the data into the simulation apparatus so as to facilitate cooperation with the simulation apparatus according to the present disclosure.

The real card manager: the real card manager may manage one or more simulation apparatuses, and has one or more reading/writing interfaces. The one or more reading/writing interfaces may be contact type (such as contactors of a card slot and the like) interfaces and/or contactless type (such as NFC and the like) interfaces to facilitate the real card manager to connect with various real cards via different types. Furthermore, the real card manager may perform the data interaction with the simulation apparatus. The real card manager may be placed fixedly (such as in a user's house), or may be a small device to be carried on (such as like in a form of wallet). The real card manager may perform the data interaction with the simulation apparatus mainly via a network interface (such as a 2G network interface, a 3G network interface, a 4G network interface or a WIFI interface) if the real card manager is placed fixedly. In addition to the network interface, the real card manager may perform the data interactions with the simulation apparatus via a near field communication (NFC) interface or a midfield communication interface (such as a Bluetooth interface, an infrared interface, a 2.4G interface, a 900M interface, a ZigBee interface and the like) when the real card manager is carried on.

In the data interaction architecture, the real card is a smart card with a smart card chip. The real card may be a functional card (such as a public transport card, a meal card, a shopping card, a membership card, a point card, an identification card and the like) or a bank card issued by a bank. The simulation apparatus may also be a smart card with a smart card chip when the simulation apparatus is a card shaped device.

Based on the above data interaction architecture, the present disclosure provides a simulation apparatus to facilitate the data interaction between the terminal and the real card manager. The present disclosure further provides a real card manager to facilitate a management of the above real card(s). The present disclosure further provides a data interaction system to facilitate the data interaction between the simulation apparatus and the real card manager. Now, the simulation apparatus, the real card manager and structures and functions thereof will be described in detail respectively.

The Simulation Apparatus

### EMBODIMENT 1

FIG. 1 is a schematic diagram of a simulation apparatus according to embodiment 1 of the present disclosure. As shown in FIG. 1, the simulation apparatus according to embodiment 1 of the present disclosure includes: a first interface 101, a wireless interface 102 and a security module 103.

The first interface 101 is configured to receive first data sent by a terminal and to send the first data to the security module 102.

The security module 103 is configured to receive the first data sent by the first interface 101, to process the first data to obtain second data, and to send the second data to the wireless interface 102.

The wireless interface 102 is configured to receive the second data sent by the security module 103 and to send the second data to a real card manager.

The wireless interface 102 is further configured to receive third data sent by the real card manager and to send the third data to the security module 103.

The security module 103 is further configured to receive the third data sent by the wireless interface 102, to process the third data to obtain fourth data, and to send the fourth data to the first interface 101.

The first interface 101 is further configured to receive the fourth data sent by the security module 103 and to send the fourth data to the terminal.

The first interface 101 may be a contact type interface, or the first interface 101 may also be a contactless type interface, or the first interface 101 may be a contact type interface and a contactless interface, so as to facilitate data interaction with the terminal via the first interface 101. The contract type interface may be a contactor, a USB interface, a serial port, an audio port or the like, for example, a version of the contact type interface chip may be TDA8035 of NXP Corp, NCN8025 of NCN Corp or the like; the contactless type interface may be a 2.4G interface, a Bluetooth interface, an infrared interface, a NFC interface, a RFID interface or the like, for example, a version of the contactless type interface chip may be QN9021, PN512, TIF 256 of Texas instruments, RC663 of NXP Corp and or like. An interface supported by the terminal may be used as the first interface 101 to cooperate with the terminal.

The wireless interface 102 may be one or a combination of a Bluetooth interface, an infrared interface, a 2.4G interface, a 900M interface, a ZigBee interface, a 2G network interface, a 3G network interface, a 4G network interface and a WIFI interface to facilitate the data interaction with the real card manager via wireless communication. Specifically, the wireless interface 102 may use the chip like SIM6320, U7500 of LongShang Corp.

If the type of the first interface 101 is different from that of the wireless interface 102, the simulation apparatus may convert the data satisfying a protocol of the first interface into data satisfying a protocol of the wireless interface and send the data satisfying the protocol of the wireless interface via the wireless interface 102 after receiving the data from the first interface 101. Certainly, the simulation apparatus may convert the data satisfying the protocol of the wireless interface into the data satisfying the protocol of the first interface and send the data satisfying the protocol of the first interface via the first interface 101 after receiving the data from the wireless interface 102. In an alternative embodiment, the first interface 101 is a NFC interface, and the wireless interface 102 is a Bluetooth interface.

When the type of the first interface 101 is same with that of the wireless interface 102, for example, the terminal supports the Bluetooth interface, the first interface 101 of the simulation apparatus may be the Bluetooth interface, and the wireless interface 102 may also be the Bluetooth interface. Then, the simulation apparatus does not need to convert the data between different interface protocols.

The security module 103 has data processing functions, such as encryption, decryption, checking, checking verifying, certificate verifying, signing, signature verifying, and data protocol converting. Data transmissions of the first interface 101 and of the wireless interface 102 are controlled by the security module 103 in embodiment 1 of the present disclosure to improve security. The security module 103 may be implemented by a software module having data processing functions, such as encryption, decryption, checking, checking verifying, certificate verifying, signing, signature verifying, and data protocol converting; or the security module 103 may be implemented by a hardware chip, for example, the security module 103 is a security chip. When the security module 103 is a security chip, only one security chip is included in the security module 103 in embodiment 1 of the present disclosure to save cost. Furthermore, if the simulation apparatus is a smart card with a smart card chip and the security module is a security chip, the security chip in the embodiment 1 may be integrated with the smart card chip into one chip, or may be a single chip. Certainly, if the simulation apparatus is a smart card without a smart card chip, the function of the smart card is performed by the security module. Specifically, the security chip may be Z8D256U of Nationz Technologies Corp or STSEL78 of Infineon Technologies Corp. In addition, the security chip may include a memory for data storing.

Based on the simulation apparatus according to embodiment 1 of the present disclosure, a connection between the terminal and the real card manager and the data interaction between therewith may be realized, and it may be realized to make transaction convenient and provide high security by using the simulation apparatus instead of the real card(s).

Further, the simulation apparatus based on embodiment 1 of the present disclosure may be configured with a memory separately so as to facilitate data storage. The separated memory may be connected to the security module 103 for data storing.

The data referred to in the present disclosure may include instructions and the like.

### EMBODIMENT 2

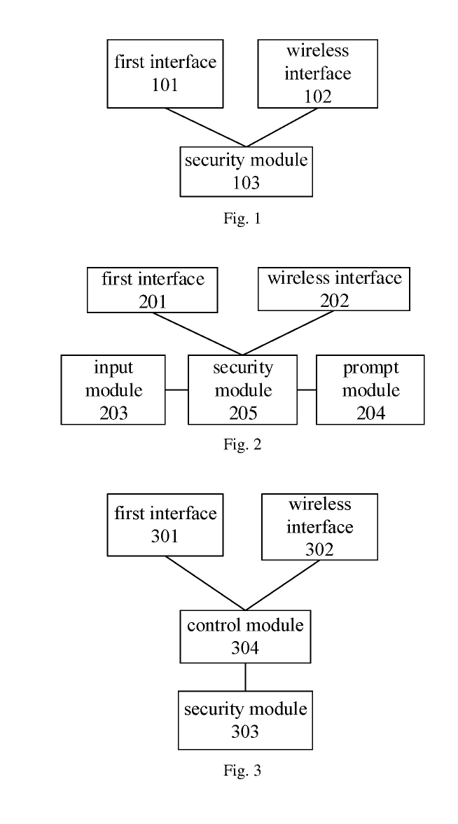

FIG. 2 is a schematic diagram of a simulation apparatus according to embodiment 2 of the present disclosure. Sample descriptions of structures may be made only in the embodiment 2, detailed descriptions of the first interface, the wireless interface and the security module may be referred to embodiment 1. As shown in FIG. 2, the simulation apparatus according to embodiment 2 of the present disclosure includes: a first interface 201, a wireless interface 202, an input module 203, a prompt module 204 and a security module 205.

The first interface 201 is configured to receive first data sent by a terminal and to send the first data to the security module 205.

The security module 205 is configured to receive the first data sent by the first interface 201, to process the first data to obtain second data, and to send the second data to the wireless interface 202.

The wireless interface 202 is configured to receive the second data sent by the security module 205 and to send the second data to the real card manager.

The wireless interface 202 is further configured to receive third data sent by the real card manager and to send the third data to the security module 205.

The security module 205 is further configured to receive the third data sent by the wireless interface 202, to process the third data to obtain fourth data, and to send the fourth data to the first interface 201.

The first interface 201 is further configured to receive the fourth data sent by the security module 205 and to send the fourth data to the terminal.

The input module 203 is configured to input fifth data.

The prompt module 204 is configured to play sixth data as a prompt.

The security module 205 is further configured to receive the fifth data inputted via the input module 203, and to send the sixth data to the prompt module 204.

The input module 203 may be one or a combination of a voice capturing device, a keyboard and a scanning device. The voice capturing device may be a microphone or the like. The keyboard may be a physical keyboard, a virtual keyboard or the like. The scanning device may be a camera or the like.

The prompt module 204 may include: a voice playing device and/or a display device. The voice playing device may be a trumpet, an earphone receiver or the like. The display device may be a display screen or the like.

Certainly, the security module in the embodiment 2 may also process the data received from the input module, and then send the data processed to the prompt module to perform a prompt. Furthermore, the security module in the embodiment 2 may also process the data received from the input module, and then send the data processed to the real card manager or to the terminal.

### EMBODIMENT 3

A difference between embodiment 3 and embodiment 1 is that, a first interface and a wireless interface are invoked by a control module in embodiment 3. Sample descriptions of structures may be made only in the embodiment 3, detailed descriptions of the first interface, the wireless interface and the security module may be referred to embodiment 1.

FIG. 3 is a schematic diagram of a simulation apparatus provided by embodiment 3 of the present disclosure. As shown in FIG. 3, the simulation apparatus according to embodiment 3 of the present disclosure includes the first interface 301, the wireless interface 302, a security module 303 and the control module 304.

The first interface 301 is configured to receive first data sent by a terminal and to send the first data to the control module 304.

The control module 304 is configured to receive the first data sent by the first interface 301, to process the first data to obtain second data, and to send the second data to the security module 303.

The security module 303 is configured to receive the second data sent by the control module 304, to process the second data to obtain third data, and to send the third data to the control module 304.

The control module 304 is further configured to receive the third data sent by the security module 303, to process the third data to obtain fourth data, and to send the fourth data to the wireless interface 302.

The wireless interface 302 is configured to receive the fourth data sent by the control module 304 and to send the fourth data to a real card manager.

The wireless interface 302 is further configured to receive fifth data sent by the real card manager and to send the fifth data to the control module 304.

The control module 304 is further configured to receive the fifth data sent by the wireless interface 302, to process the fifth data to obtain sixth data, and to send the sixth data to the security module 303.

The security module 303 is further configured to receive the sixth data sent by the control module 304, to process the sixth data to obtain seventh data, and to send the seventh data to the control module 304.

The control module 304 is further configured to receive the seventh data sent by the security module 303, to process the seventh data to obtain eighth data, and to send the eighth data to the first interface 301.

The first interface 301 is further configured to receive the eighth data sent by the control module 304 and to send the eighth data to the terminal.

The control module 304 is configured to control the data interaction among the first interface 301, the wireless interface 302 and the security module 303. The control module may be implemented by a software module having data processing functions, such as data protocol converting functions, information extracting functions, forwarding operating functions and the like; alternatively the control module may be implemented by a hardware chip, for example, the control module is a control chip. Specifically, when the control module is a control chip, the control chip may be STM32 of ST Crop, Z32 of Nationz Technologies Corp and the like. Furthermore, the control chip may be configured with a memory for data storing. A process performed by the control module to the data may include but not be limited to: one or a combination of data protocol converting, information extracting, forwarding operating and the like.

The security module and the control module provided in the present disclosure may be integrated into one module, or may be two modules separately that are integrated into one chip.

Based on the simulation apparatus according to the embodiment 3 of the present disclosure, it may be realized to connect the terminal to the real card manager or data interacting via the simulation apparatus. Furthermore, it may be realized to make transaction convenient and provide high security by using the simulation apparatus instead of the real card(s).

Further, the simulation apparatus based on embodiment 3 of the present disclosure may be configured with a memory separately so as to facilitate data storage. The separated memory may be connected to the control module 304, or may be connected to the security module 303, for data storing.

The data referred to in the present disclosure may also include instructions and the like.

### EMBODIMENT 4

A difference between embodiment 4 and embodiment 2 is that, a first interface, a wireless interface, an input module, a prompt module are invoked by a control module in embodiment 4. Sample descriptions of structures may be made only in the embodiment 4, detailed descriptions of the first interface, the wireless interface, the security module, the input module, the prompt module and the control module may be referred to other embodiments.

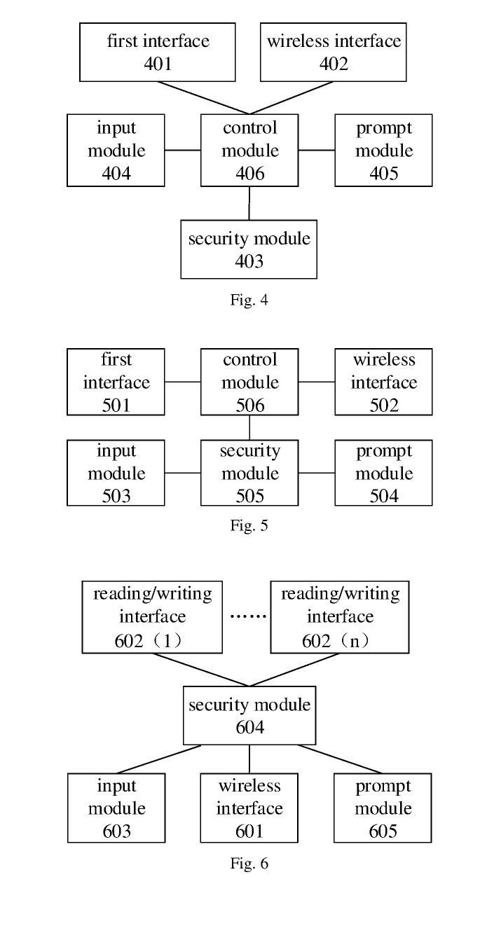

FIG. 4 is a schematic diagram of a simulation apparatus according to embodiment 4 of the present disclosure. As shown in FIG. 4, the simulation apparatus according to embodiment 4 of the present disclosure includes: the first interface 401, the wireless interface 402, a security module 403, the input module 404, the prompt module 405 and the control module 406.

The first interface 401 is configured to receive first data sent by a terminal and to send the first data to the control module 406.

The control module 406 is configured to receive the first data sent by the first interface 401, to process the first data to obtain second data, and to send the second data to the security module 403.

The security module 403 is configured to receive the second data sent by the control module 406, to process the second data to obtain third data, and to send the third data to the control module 406.

The control module 406 is further configured to receive the third data sent by the security module 403, to process the third data to obtain fourth data, and to send the fourth data to the wireless interface 402.

The wireless interface 402 is configured to receive the fourth data sent by the control module 406 and to send the fourth data to a real card manager.

The wireless interface 402 is further configured to receive fifth data sent by the real card manager and to send the fifth data to the control module 406.

The control module 406 is further configured to receive the fifth data sent by the wireless interface 402, to process the fifth data to obtain sixth data, and to send the sixth data to the security module 403.

The security module 403 is further configured to receive the sixth data sent by the control module 406, to process the sixth data to obtain seventh data, and to send the seventh data to the control module 406.

The control module 406 is further configured to receive the seventh data sent by the security module 403, to process the seventh data to obtain eighth data, and to send the eighth data to the first interface 401.

The first interface 401 is further configured to receive the eighth data sent by the control module 406 and to send the eighth data to the terminal.

The input module 404 is configured to input ninth data.

The prompt module 405 is configured to play tenth data as a prompt.

The control module 406 is further configured to receive the ninth data inputted via the input module 404 and to send the tenth data to the prompt module 405.

Certainly, the control module according to the embodiment 4 may also process the data received from the input module and then send the data processed to the prompt module to perform a prompt. Furthermore, the control module may also process the data received from the input module and then send the data processed to the real card manager or the terminal. Alternatively, the control module may process the data received from the input module and then send the data processed to the security module to be processed. Alternatively, the control module may also process the data received from the security module and then send the data processed to the prompt device to perform a prompt.

### EMBODIMENT 5

A difference between embodiment 5 and embodiment 1 is that, a first interface and a wireless interface are invoked by a control module in embodiment 5. Sample descriptions of structures may be made only in the embodiment 5, detailed descriptions of the first interface, the wireless interface, the security module, the input module, the prompt module and the control module may be referred to other embodiments. An input module and a prompt module are invoked by a security module.

FIG. 5 is a schematic diagram of a simulation apparatus according to embodiment 5 of the present disclosure. As shown in FIG. 5, the simulation apparatus according to embodiment 5 of the present disclosure includes: the first interface 501, the wireless interface 502, the input module 503, the prompt module 504, the security module 505 and the control apparatus 506;

The first interface 501 is configured to receive first data sent by a terminal and to send the first data to the control module 506.

The control module 506 is configured to receive the first data sent by the first interface 501, to process the first data to obtain second data, and to send the second data to the security module 505.

The security module 505 is configured to receive the second data sent by the control module 506, to process the second data to obtain third data, and to send the third data to the control module 506.

The control module 506 is further configured to receive the third data sent by the security module 505, to process the third data to obtain fourth data, and to send the fourth data to the wireless interface 502.

The wireless interface 502 is configured to receive the fourth data sent by the control module 506 and to send the fourth data to a real card manager.

The wireless interface 502 is further configured to receive fifth data sent by the real card manager and to send the fifth data to the control module 506.

The control module 506 is further configured to receive the fifth data sent by the wireless interface 502, to process the fifth data to obtain sixth data, and to send the sixth data to the security module 505.

The security module 505 is further configured to receive the sixth data sent by the control module 506, to process the sixth data to obtain seventh data, and to send the seventh data to the control module 506.

The control module 506 is further configured to receive the seventh data sent by the security module 505, to process the seventh data to obtain eighth data, and to send the eighth data to the first interface 501.

The first interface 501 is further configured to receive the eighth data sent by the control module 506 and to send the eighth data to the terminal.

The input module 503 is configured to input ninth data.

The prompt module 504 is configured to play tenth data as a prompt; and

The security module 505 is further configured to receive the ninth data inputted via the input module 503 and to send the tenth data to the prompt module 504.

The data referred to in the present disclosure may include instructions and the like.

Certainly, in the embodiment, the security module may also process the data received from the input module and then send the data processed to the prompt module to perform a prompt. Furthermore, the security module may also process the data received from the input module and then send the data processed to the control module, after that, the data processed is send by the control module to the real card manager or the terminal.

Certainly, the simulation apparatus based on embodiment 1, embodiment 2, embodiment 3, embodiment 4 and embodiment 5 may further include a battery. The battery may be a non-chargeable battery or may be a chargeable battery. The simulation apparatus may further include a charge controller if the battery is chargeable. The charge controller may be connected to the battery and is configured to receive electric power to charge the battery. Certainly, the charge controller may be disposed inside the battery or be disposed inside the security module, or be disposed inside the control module. When charge through the first interface, the charge controller may also be disposed at the first interface having the charge function. Certainly, the simulation apparatus may be configured with a separated charge interface (such as a USB interface), the charge controller may be disposed at the charge interface.

### EMBODIMENT 6

A difference between embodiment 6 and embodiments 1 to 5 is that, the simulation apparatus according to the embodiment 6 is a combination of a mobile device and an electronic signature token. A first interface is disposed on the mobile terminal, a wireless interface is disposed on the electronic signature token, and a security module is disposed on the electronic signature token.

An input module and a prompt module may be both disposed on the mobile device, or both disposed on the electronic signature token. Alternatively, one of them may be disposed on the mobile device, and another one is disposed on the electronic signature token.

The control module may be disposed on the mobile device or on the electronic signature token.

The description of the embodiment is same with description of embodiments 1 to 5, which is not elaborated herein.

### EMBODIMENT 7

A difference between embodiment 7 and embodiments 1 to 5 is that, the simulation apparatus according to the embodiment 7 is a combination of a mobile device and an electronic signature token. A first interface is disposed on the electronic signature token, a wireless interface is disposed on the mobile device, and a security module is disposed on the electronic signature token.

An input module and a prompt module may be both disposed on the mobile device, or both disposed on the electronic signature token. Alternatively, one of them may be disposed on the mobile device, and another one is disposed on the electronic signature token.

The control module may be disposed on the mobile device or on the electronic signature token.

The description of the embodiment is same with description of embodiments 1 to 5, which is not elaborated herein.

### EMBODIMENT 8

A difference between embodiment 8 and embodiments 1 to 5 is that, the simulation apparatus according to the embodiment 8 is a combination of a mobile device and an electronic signature token. A first interface and a wireless interface are disposed on the mobile terminal, and a security module is disposed on the electronic signature token.

An input module and a prompt module may be both disposed on the mobile device, or both disposed on the electronic signature token. Alternatively, one of them may be disposed on the mobile device, and another one is disposed on the electronic signature token.

The control module may be disposed on the mobile device or on the electronic signature token.

The description of the embodiment is same with description of embodiments 1 to 5, which is not elaborated herein.

It is to be illustrated that, in the above embodiments 1 to 8, the data interaction may be directly performed among the components (such as if the simulation apparatus is a phone, the security module of the phone directly acquire data via the first interface), or indirectly performed among the components (such as if the simulation apparatus is a combination of a phone and a Key Token, the data received via the first interface disposed on the phone may be transmitted to the security module disposed on the Key Token via a connection path (such as an audio interface) between the phone and the Key Token).

In the above embodiments 1 to 8, a process performed by the security module on the data received includes: one or a combination of encryption, decryption, checking, checking verifying, certificate verifying, signing, signature verifying, and data protocol converting.

Real Card Manager

### EMBODIMENT 9

FIG. 6 is a schematic diagram of a real card manager according to embodiment 9 of the present disclosure. As shown in FIG. 9, the real card manager according to embodiment 9 of the present disclosure includes: a wireless interface 601, one or more reading/writing interfaces 602, an input module 603, a security module 604 and a prompt module 605.

The wireless interface 601 is configured to receive first data sent by a simulation apparatus and to send the first data to the security module 604.

The security module 604 is configured to receive the first data sent by the wireless interface 601, to process the first data to obtain second data, and to send the second data to the one or more reading/writing interfaces 602.

The one or more reading/writing interfaces 602 are configured to receive the second data sent by the security module 604 and to send the second data to a real card.

The one or more reading/writing interfaces 602 are further configured to receive third data sent by the real card and to send the third data to the security module 604.

The security module 604 is further configured to receive the third data sent by the one or more reading/writing interfaces 602, to process the third data to obtain fourth data, and to send the fourth data to the wireless interface 601.

The wireless interface 601 is further configured to receive the fourth data sent by the security module 604 and to send the fourth data to the simulation apparatus.

The input module 603 is configured to input fifth data.

The prompt module 605 is configured to play sixth data as a prompt.

The security module 604 is further configured to receive the fifth data inputted via the input module 603 and to send the sixth data to the prompt data 605.

The wireless interface 601 may be one or a combination of a Bluetooth interface, an infrared interface, a 2.4G interface, a 900M interface, a ZigBee interface, a 2G network interface, a 3G network interface, a 4G network interface and a WIFI interface so as to facilitate data interaction with the simulation apparatus via wireless communication. Specifically, the wireless interface 601 may use the chip like SIM6320, U7500 of LongShang Corp.

The one or more reading/writing interfaces 602 may be at least one contact type interface, or may be at least one contactless type interface, or may be at least one contact interface and at least one contactless interface, so as to facilitate data interaction with various real cards via the one or more reading/writing interfaces 602. One reading/writing interface 602 reads data from or writes data into one real card. Shown as FIG. 6 in detail, there are the reading/writing interface 602(1) . . . the reading/writing interface 602(n), in which, n≧2 and n is a natural number. Specifically, the contract type interface may be a contactor or the like; the contactless type interface may be a NFC interface or the like. A version of the contact type interface chip may be TDA8035 of NXP Corp, NCN8025 of NCN Corp or the like; the version of the contactless type interface may be PN512, RC663 of NXP Corp or the like.

Furthermore, embodiments of the present disclosure further provide two structures of the one or more reading/writing interfaces. However, embodiments of the present disclosure are not limited to this.

Structure 1:

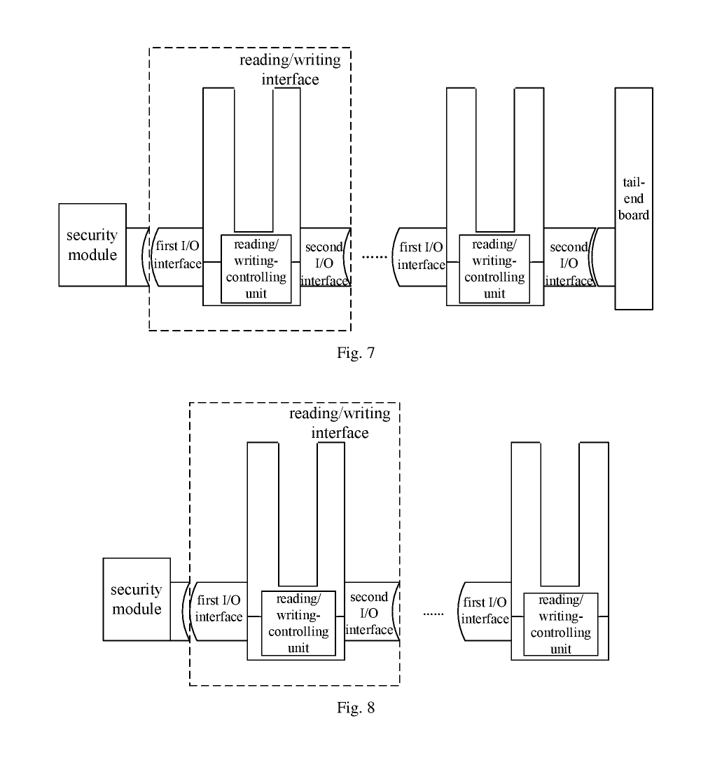

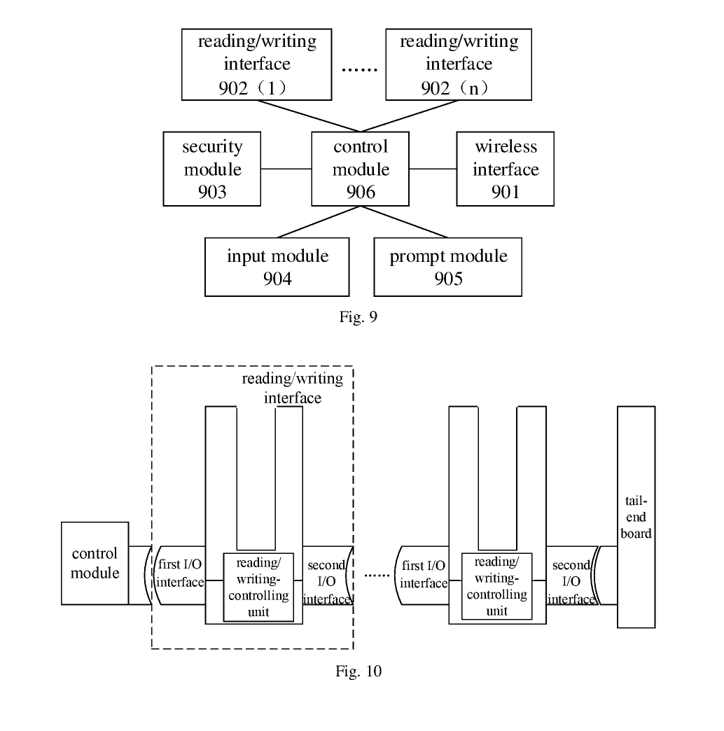

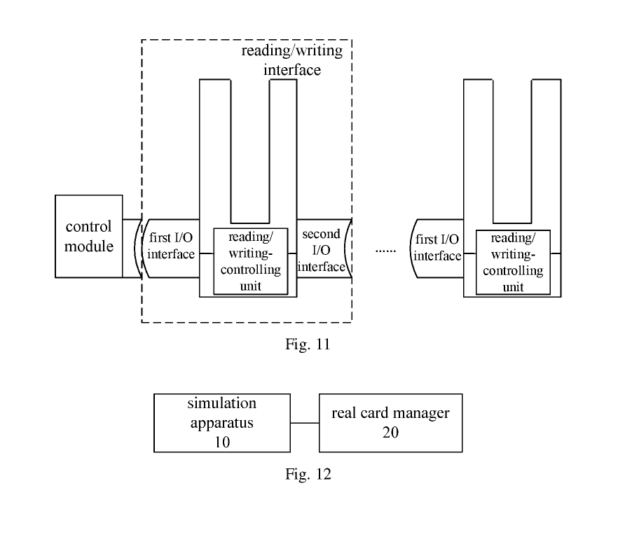

The real card manager provided in the present disclosure further includes: a tail-end board; the one or more reading/writing interfaces are at least two reading/writing interfaces connected one by one, each reading/writing interfaces includes: a first I/O interface, a second I/O interface, a reading/writing-controlling unit and a memory (not shown); shown as FIG. 7 in detail.

The first I/O interface of a first reading/writing interface of the at least two reading/writing interfaces is connected to the security module.

The first I/O interface of a second reading/writing interface of the at least two reading/writing interfaces is connected to the second I/O interface of the first reading/writing interface, in which the first I/O interface of a later reading/writing interface of the at least two reading/writing interfaces is connected to the second I/O interface of an adjacent former reading/writing interface successively.

The second I/O interface of a last reading/writing interface is connected to the tail-end board with tail-end information stored in.

In each reading/writing interface, the first I/O interface and the second I/O interface are each connected to the reading/writing-controlling unit.

The reading/writing-controlling unit of each of the at least two reading/writing interfaces is configured to read the third data from the real card and to write the second data into the real card.

The memory of each of the at least two reading/writing interfaces is configured to store a respective address of each of the at least two reading/writing interfaces.

As the data is transmitted via an I/O interface connected one by one, the security module only need to connect to the first I/O interface. Such that the number of I/O interfaces of the security module is reduced. As the tail-end board connected to the last reading/writing interface is configured, the last reading/writing interface may be learnt when the security module detects the tail-end information, thus improving efficiency of detecting the interfaces.

The reading/writing-controlling unit may be integrated into one unit, or may be two units separately (i.e. a reading/writing unit and a controlling unit), which is not limited in the present disclosure. If the reading/writing-controlling unit is implemented as two units, each I/O interface may be connected to the controlling unit and the reading/writing unit respectively.

Structure 2:

The one or more reading/writing interfaces are at least two reading/writing interfaces connected one by one, the last reading/writing interface includes the first I/O interface, the reading/writing-controlling unit and the memory; each of the at least two reading/writing interfaces except the last reading/writing interface includes: the first I/O interface, the second I/O interface, the reading/writing-controlling unit and the memory (not shown); shown as FIG. 8 in detail.

The first I/O interface of a first reading/writing interface of the at least two reading/writing interfaces is connected to the security module.

The first I/O interface of a second reading/writing interface of the at least two reading/writing interface is connected to the second I/O interface of the first reading/writing interface, in which the first I/O interface of a later reading/writing interface of the at least two reading/writing interfaces is connected to the second I/O interface of an adjacent former reading/writing interface successively.

In each reading/writing interface, the first I/O interface and the second I/O interface are connected to the reading/writing-controlling unit.

The reading/writing-controlling unit of each of the at least two reading/writing interfaces is configured to read the third data from the real card and to write the second data into the real card.

The memory of each of the at least two reading/writing interfaces is configured to store a respective address of each of the at least two reading/writing interfaces.

The memory of the last reading/writing interface is further configured to store tail-end information.

As the data is transmitted via an I/O interface connected one by one, the security module only need to connect to the first I/O interface. Such that the number of I/O interfaces of the security module is reduced. As the tail-end information is stored in the last reading/writing interface, the last reading/writing interface may be learnt when the security module detects the tail-end information, thus improving efficiency of detecting the interfaces.

The reading/writing-controlling unit may be integrated into one unit, or may be two units separately (i.e. a reading/writing unit and a controlling unit), which is not limited in the present disclosure. If the reading/writing-controlling unit is implemented as two units, each I/O interface may be connected to the controlling unit and the reading/writing unit respectively.

Furthermore, when connecting the I/O interfaces, the I/O interfaces are coupled to each other.

The input module 603 may be one or a combination of a voice capturing device, a keyboard and a scanning device. The voice capturing device may be a microphone or the like. The keyboard may be a physical keyboard, a virtual keyboard or the like. The scanning device may be a camera or the like.

The prompt module 605 is configured to play the sixth data as a prompt. The prompt module 605 may include: a voice playing device and/or a display device. The voice playing device may be a trumpet, an earphone receiver or the like. The display device may be a display screen or the like.

The security module 604 has data processing functions, such as encryption, decryption, checking, checking verifying, certificate verifying, signing, signature verifying, and data protocol converting. The security module 604 may be implemented by a software module having data processing functions, such as encryption, decryption, checking, checking verifying, certificate verifying, signing, signature verifying, and data protocol converting; or the security module 604 may be implemented by a hardware chip, for example, the security module 604 is a security chip. When the security module 604 is a security chip, only one security chip is included in the security module 604 in embodiment 9 of the present disclosure to save cost. The data transmissions of the wireless interface 601 and of the one or more reading/writing interfaces 602 are controlled by the security module 604 to improve security in embodiment 9 of the present disclosure. Specifically, if the security module 604 is a security chip, the security chip may be Z8D256U of Nationz Technologies Corp or STSEL78 of Infineon Technologies Corp. In addition, the security chip may include a memory for data storing.

Certainly, the security module in the embodiment 9 may also process the data received from the input module, and then send the data processed to the prompt module to perform a prompt. Furthermore, the security module in the embodiment 9 may also process the data received from the input module, and then send the data processed to the real card or to the simulation apparatus.

Based on the real card manager according to embodiment 9 of the present disclosure, it may be realized to manage the real card(s) to provide high security while making the transaction convenient by cooperating the real card manager with the simulation apparatus.

Further, in order to facilitate usage of the real card manager, the real card manager according to embodiment 9 of the present disclosure further includes: a power. The power may be a direct plug-in power or a battery. And when the power is the battery, the real card manager also includes supporting parts, such as a power charger.

Further, in order to facilitate data storage, the real card manager according to embodiment 9 of the present disclosure further includes: a memory. The memory is connected to a security module, for data storing.

The data referred to in the present disclosure may further include instructions and the like.

### EMBODIMENT 10

A difference between embodiment 10 and embodiment 9 is that, a wireless interface, one or more reading/writing interfaces, an input module and a prompt module are invoked by a control module in embodiment 10. Sample descriptions of structures may be made only in the embodiment 10, detailed descriptions of the wireless interface, reading/writing interfaces, the security module, the input module, the prompt module and the control module may be referred to other embodiments.

FIG. 9 is a schematic diagram of a real card manager according to embodiment 10 of the present disclosure. As shown in FIG. 9, the real card manager according to embodiment 10 of the present disclosure includes: the wireless interface 901, the one or more reading/writing interfaces 902, a security module 903, the input module 904, the prompt module 905 and the control module 906.

The wireless interface 901 is configured to receive first data sent by a simulation apparatus and to send the first data to the control module 906.

The control module 906 is configured to receive the first data sent by the wireless interface 901, to process the first data to obtain second data, and to send the second data to the security module 903.

The security module 903 is configured to receive the second data sent by the control module 906, to process the second data to obtain third data, and to send the third data to the control module 906.

The control module 906 is further configured to receive the third data sent by the security module 903, to process the third data to obtain fourth data, and to send the fourth data to the one or more reading/writing interfaces 902.

The one or more reading/writing interfaces 902 are configured to receive the fourth data sent by the control module 906 and to send the fourth data to a real card.

The one or more reading/writing interfaces 902 are further configured to receive fifth data sent by the real card and to send the fifth data to the control module 906.

The control module 906 is further configured to receive the fifth data sent by the one or more reading/writing interfaces 902, to process the fifth data to obtain sixth data, and to send the sixth data to the security module 903.

The security module 903 is further configured to receive the sixth data sent by the control module 906, to process the sixth data to obtain seventh data, and to send the seventh data to the control module 906.

The control module 906 is further configured to receive the seventh data sent by the security module 903, to process the seventh data to obtain eighth data, and to send the eighth data to the wireless interface 901.

The wireless interface 901 is further configured to receive the eighth data sent by the control module 906 and to send the eight data to the simulation apparatus.

The input module 904 is configured to input ninth data.

The prompt module 905 is configured to play tenth data as a prompt; and

The control module 906 is further configured to receive the ninth data inputted via the input module 904 and to send the tenth data to the prompt device 905.

The control module 906 is configured to control the data interaction among the wireless interface 901, the one or more reading/writing interfaces 902, the input module 903, the prompt module 904 and the security module 903. The control module may be implemented by a software module having data processing functions, such as data protocol converting functions, information extracting functions, forwarding operating functions and the like; alternatively the control module may be implemented by a hardware chip, for example, the control module is a control chip. Specifically, if the control module is a control chip, the control chip may be STM 32 of ST Corp, Z32 of Nationz Technologies Corp and the like. Furthermore, the control chip may include a memory for data storing. A process performed by the control module to the data may include but not be limited to: one or a combination of data protocol converting, information extracting, forwarding operation and the like.

Based on the real card manager according to the embodiment 10 of the present disclosure, it may be realized to manage the real card(s) to provide high security while making the transaction convenient by cooperating the real card manager with the simulation apparatus.

Further, in order to facilitate usage of the real card manager, the real card manager according to embodiment 10 of the present disclosure further includes: a power. The power may be a direct plug-in power or a battery. And when the power is the battery, the real card manager also includes supporting parts, such as a power charger.

Further, in order to facilitate data storage, the real card manager according to embodiment 10 of the present disclosure further includes: a memory. The memory is connected to a security module for data storing.

The data referred to in the present disclosure may further include instructions and the like.

The security module and the control module provided by the present disclosure may be integrated into one module, or be two modules separately that are integrated into one chip.

Certainly, the control module according to the embodiment may also process the data received from the input module and then send the data processed to the prompt device to perform a prompt. Furthermore, the control module may also process the data received from the input module and then send the data processed to the real card or the simulation apparatus. Alternatively, the control module may process the data received from the input module and then send the data processed to the security module to be processed. Alternatively, the control module may also process the data received from the security module and then send the data processed to the prompt device to perform a prompt.

Data Interactive System

FIG. 12 is a schematic diagram of a data interactive system of the present disclosure. As shown in FIG. 12, the data interactive system of the present disclosure includes: a simulation apparatus 10 and a real card manager 20.

The simulation apparatus 10 is configured to receive first data sent by a terminal, to process the first data to obtain second data, and to send the second data to the real card manager 20.

The real card manager 20 is configured to receive the second data sent by the simulation apparatus 10, to process the second data to obtain third data, and to send the third data to a real card.

The real card manager 20 is further configured to receive fourth data sent by the real card, to process the fourth data to obtain fifth data, and to send the fifth data to the simulation apparatus 10.

The simulation apparatus 10 is further configured to receive the fifth data sent by the real card manager 20, to process the fifth data to obtain sixth data, and to send the sixth data to the terminal.

Specifically, with the simulation apparatus 10 of the present disclosure, the data received from the terminal may be sent to the real card manager 20, or the data received from the real card manager 20 may also be sent to the terminal, to finish the data interaction between the terminal and the real card manager 20.

Certainly, the data transmitted between the simulation apparatus 10 and the real card manager 20 may be independent from the terminal. That is, the data sent from the simulation apparatus 10 to the real card manager 20 is generated by the simulation apparatus 10 itself or is acquired from other external devices rather than the terminal; similarly, the data sent by the real card manager 20 to the simulation apparatus 10 may be processed by the simulation apparatus 10 independently and does not need to be sent to the terminal.

The terminal may be a card reading terminal or a card reading/writing terminal. Specially, the card reading terminal comprises: a payment terminal and/or a functional terminal; or the card reading/writing terminal comprises: a payment terminal and/or a functional terminal. It can be seen that, the data interactive system according to the present disclosure may provide a solution for making a transaction convenient for a user and for providing high security.

The simulation apparatus 10 and the real card manager 20 in the data interactive system may refer to the simulation apparatus and the real card manager of the foregoing related embodiments respectively, which are not elaborated herein.

The term “connected” referred to in the present disclosure may be direct connections or indirect connections.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Reference throughout this specification to “an embodiment,” “some embodiments,” “example,” “a specific example,” or “some examples,” means that a particular feature, structure, material, or characteristic described in connection with the embodiment or example is included in at least one embodiment or example of the present disclosure. In the specification, the terms mentioned above are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments are exemplary and cannot be construed to limit the present disclosure, and changes, alternatives, and modifications can be made in the embodiments by those skilled in the art without departing from scope of the present disclosure.

1. A simulation apparatus, comprising:
a first interface, configured to receive first data sent by a terminal;
a security module, configured to receive the first data sent by the first interface and to process the first data to obtain second data; and
a wireless interface, configured to receive the second data sent by the security module and to send the second data to a real card manager;
wherein the wireless interface is further configured to receive third data sent by the real card manager and to send the third data to the security module;
the security module is further configured to receive the third data sent by the wireless interface, to process the third data to obtain fourth data, and to send the fourth data to the first interface; and
the first interface is further configured to receive the fourth data sent by the security module and to send the fourth data to the terminal.

2. The simulation apparatus according to claim 1, further comprising:
an input module, configured to input fifth data; and
a prompt module, configured to play sixth data as a prompt;
wherein the security module is further configured to receive the fifth data inputted via the input module and to send the sixth data to the prompt module.

3. The simulation apparatus according to claim 1, further comprising:
a control module,
wherein the control module is configured to process the first data received from the first interface and to send the processed first data to the security module;
the control module is further configured to process the second data received from the security module and to send the processed second data to the wireless interface;
the control module is further configured to process the third data received from wireless interface and to send the processed third data to the security module; and
the control module is further configured to process the fourth data received from the security module and to send the processed fourth data to the first interface.

4. The simulation apparatus according to claim 3, further comprising:
an input module, configured to input ninth data; and
a prompt module, configured to play tenth data as a prompt;
wherein the control module is further configured to receive the ninth data inputted via the input module and to send the tenth data to the prompt module.

5. The simulation apparatus according to claim 3, further comprising:
an input module, configured to input ninth data; and
a prompt module, configured to play tenth data as a prompt;
wherein the security module is further configured to receive the ninth data inputted via the input module and to send the tenth data to the prompt module.

6. The simulation apparatus according to claim 1,
wherein the simulation apparatus is a simulation card, a mobile device or an electronic signature token.

7. The simulation apparatus according to claim 6, wherein the simulation card comprises: a smart card chip.

8. The simulation apparatus according to claim 1, wherein the simulation apparatus comprises a mobile device and an electronic signature token, the first interface is disposed on the mobile device, the wireless interface is disposed on the electronic signature token, and the security module is disposed on the electronic signature token; or the simulation apparatus comprises a mobile device and an electronic signature token, the first interface is disposed on the electronic signature token, the wireless interface is disposed on the mobile device, and the security module is disposed on the electronic signature token; or the simulation apparatus comprises a mobile device and an electronic signature token, the first interface and the wireless interface are disposed on the mobile device, and the security module is disposed on the electronic signature token.

9-10. (canceled)

11. The simulation apparatus according to claim 10, wherein the security module is a security chip or security chipset.

12. The simulation apparatus according to claim 11, wherein the security module comprises only one security chip.

13. A real card manager, comprising:
a wireless interface, configured to receive first data sent by a simulation apparatus;
a security module, configured to receive the first data sent by the wireless interface and to process the first data to obtain second data;
one or more reading/writing interfaces, configured to receive the second data sent by the security module and to send the second data to a real card;
wherein the one or more reading/writing interfaces are further configured to receive third data sent by the real card and to send the third data to the security module;
the security module is further configured to receive the third data sent by the one or more reading/writing interfaces, to process the third data to obtain fourth data, and to send the fourth data to the wireless interface; and
the wireless interface is further configured to receive the fourth data sent by the security module and to send the fourth data to the simulation apparatus;
an input module, configured to input fifth data; and
a prompt module, configured to play sixth data as a prompt;
wherein the security module is further configured to receive the fifth data inputted via the input module and to send the sixth data to the prompt module.

14. The real card manager according to claim 13, further comprising: a tail-end board, wherein the one or more reading/writing interfaces are at least two reading/writing interfaces connected one by one, each of the at least two reading/writing interfaces comprises: a first I/O interface, a second I/O interface, a reading/writing-controlling unit and a memory;
the first I/O interface of a first reading/writing interface of the at least two reading/writing interfaces is connected to the security module;
the first I/O interface of a second reading/writing interface of the at least two reading/writing interfaces is connected to the second I/O interface of the first reading/writing interface, wherein the first I/O interface of a later reading/writing interface of the at least two reading/writing interfaces is connected to the second I/O interface of an adjacent former reading/writing interface successively;
the second I/O interface of a last reading/writing interface of the at least two reading/writing interfaces is connected to the tail-end board with tail-end information stored in;
the first I/O interface and the second I/O interface of each of the at least two reading/writing interfaces are connected to the reading/writing-controlling unit;
the reading/writing-controlling unit of each of the at least two reading/writing interfaces is configured to read the third data from the real card and to write the second data into the real card; and
the memory of each of the at least two reading/writing interfaces is configured to store a respective address of each of the at least two reading/writing interfaces.

15. The real card manager according to claim 13, wherein the one or more reading/writing interfaces are at least two reading/writing interfaces connected one by one, a last reading/writing interface of the at least two reading/writing interfaces comprises a first I/O interface, a reading/writing-controlling unit and a memory; each of the at least two reading/writing interfaces except the last reading/writing interface comprises:
a first I/O interface, a second I/O interface, a reading/writing-controlling unit and a memory;
the first I/O interface of a first reading/writing interface of the at least two reading/writing interfaces is connected to the security module;
the first I/O interface of a second reading/writing interface of the at least two reading/writing interface is connected to the second I/O interface of the first reading/writing interface, wherein the first I/O interface of a later reading/writing interface of the at least two reading/writing interfaces is connected to the second I/O interface of an adjacent former reading/writing interface successively;
the first I/O interface and the second I/O interface of each of the at least two reading/writing interface are connected to the reading/writing-controlling unit;
the reading/writing-controlling unit of each of the at least two reading/writing interfaces is configured to read the third data from the real card and to write the second data into the real card;
the memory of each of the at least two reading/writing interfaces is configured to store a respective address of each of the at least two reading/writing interfaces; and
the memory of the last reading/writing interface is further configured to store tail-end information.

16. The real card manager according to claim 13, further comprising:
a control module,
wherein the control module is configured to process the first data received from the first interface and to send the processed first data to the security module;
the control module is further configured to process the second data received from the security module and to send the processed second data to the one or more reading/writing interfaces;
the control module is further configured to process the third data received from the one or more reading/writing interfaces and to send the processed third data to the security module; and
the control module is further configured to process the fourth data received from the security module and to send the processed fourth data to the first interface.

17-18. (canceled)

19. The real card manager according to claim 13, wherein the security module is a security chip.

20. The real card manager according to claim 19, wherein the security module comprises one security chip.

21. A data interactive system, comprising a simulation apparatus and a real card manager, wherein
the simulation apparatus is configured to receive first data sent by a terminal, to process the first data to obtain second data and to send the second data to the real card manager;
the real card manager is configured to receive the second data sent by the simulation apparatus, to process the second data to obtain third data, and to send the third data to a real card;
the real card manager is further configured to receive fourth data sent by the real card, to process the fourth data to obtain fifth data, and the send the fifth data to the simulation apparatus;
the simulation apparatus is further configured to receive the fifth data sent by the real card manager, to process the fifth data to obtain sixth data, and to send the sixth data to the terminal.

22. The data interactive system according to claim 21, wherein the terminal is a card reading terminal or a card reading/writing terminal.

23. The data interactive system according to claim 22, wherein the card reading terminal comprises: a payment terminal and/or a functional terminal; or the card reading/writing terminal comprises: a payment terminal and/or a functional terminal.
